(19) United States
(12) Patent Application Publication
(10) Pub. No.: US 2012/0130784 A1
(43) Pub. Date: May 24, 2012

(54) PROMOTING GROUP DEALS ON THE INTERNET

(76) Inventors: Lance Neuhauser, New York, NY (US); David J. Barnes, Chicago, IL (US); Andrew J. Chomer, Brooklyn, NY (US); Michael J. Ciavarelli, Hermosa Beach, CA (US); Zachary R. Knudson, Rochester, MN (US)

(21) Appl. No.: 12/951,798

(22) Filed: Nov. 22, 2010

(51) Int. Cl. G06Q 30/00

(52) U.S. Cl. 705/14.16

(57) ABSTRACT

A system and method of promoting group deals on the Internet, which includes providing an Internet-based platform, the platform including a step for individuals to join, wherein individuals who join are designated as members of the Internet-based platform. The system also provides a step for members to invite merchants to join the platform and to offer deals on the platform. Members receive awards for influencing members to join as well as for influencing other members to purchase deals.

### FIELD AND BACKGROUND OF THE INVENTION

The present invention relates generally to the field of Internet marketing, and in particular to a new and useful method and program for promoting group deals on the Internet utilizing such platforms and social networking websites.

U.S. Pat. No. 7,693,748 to Mesaros, owned by eWinWin, Inc., proprietor of the ewinwin.com website, teaches a system and method for aggregating demand. At least one seller may sponsor a deal room to aggregate selling goods/services from a plurality of buyers. The demand aggregation system can include a dashboard for allowing the at least one seller to set up deal rooms, price curves, offers, products, customers, and/or customer groups, for example. The dashboard can include a plurality of wizards for configuring such information. The demand aggregation system can also include seller displays for notifying buyers of changes in prices relative to ship dates and times of order. The demand aggregation system can also include a predictive modeling and reporting function. An algorithm is employed to utilize product information to post a probability chart on a product price point.

U.S. Pat. No. 7,747,473 to Mesaros also owned by eWinWin, Inc., teaches a demand aggregation system which includes buyer sponsored deal rooms, seller sponsored deal rooms, and multiple buyer and multiple seller sponsored deal rooms. Moreover, the demand aggregation system includes a customer relations management (“CRM”) package. In the CRM package, information on buyer and prospective buyers are loaded into a database that can include information such as: individual name; company name and address; email address; phone number; cell number; products purchased; volumes; time of purchase. Further the CRM package can be integrated with the demand aggregation system as well as a customer resource planning system.

U.S. Pat. No. 7,480,627 to Van Horn et al. teaches a method and system that enables partner websites to join in the sale of products/services via an on-line group-buying sale business method. A seller registers a list of products/services to be displayed on partner sites. Customers/visitors who access partner sites may link to one or more on-line group-buying sales conducted on an owner's main site. Accordingly, the method and system enable a super demand aggregation for products/services offered for sale by the on-line group-buying sale business method. The invention provides a partner menu tree that allows partners to pre-select products/categories for display to customers linking to the on-line group-buying sale from their partner site. Sellers may provide particular products, services, categories, and abstract terms to help partners select which products/services to display for customers from among all the on-line group-buying sale products/services.

U.S. Pat. No. 7,720,722 to Ho et al. teaches a system and method which involves the listing of items and relationships on social networking sites. Specifically, it teaches a system that receives, at a network-based social platform, a request from a first user of the network-based social platform. The request is to add an item to a list associated with a second user of the network-based social platform. The list is for watching items offered for sale on a network-based marketplace. Next, the system determines whether the first user is authorized to add the item to the list associated with the second user based on relationship information that identifies a predetermined relationship between the first user and the second user on the network-based social platform. Finally, the system communicates the request to the network-based marketplace to add the item to the list associated with the second user.

A need remains, however, for an effective system and method, for recruiting merchants and buyers and for promoting group deals through a social networking website.

### SUMMARY OF THE INVENTION

Embodiments of the present invention provide a method of promoting group deals on the Internet, which includes providing an Internet-based platform, the platform including a means for individuals to join, wherein individuals who join are designated as members of the Internet-based platform. Although the word Internet is part of various registered trademarks, it is used herein as the most indicative term for a computer network consisting of a worldwide network of computer networks that use a common, e.g. the TCP/IP network protocols to facilitate data transmission and exchange.

The system and computer program for implementing the invention provides means for members to invite merchants to offer deals on the Internet-based platform and for the merchants to accept the invitations. The system also provides a means for a merchant to offer a deal on the Internet-based platform. The system provides an award to the member who invited the merchant, if the merchant offers the deal and the deal is successful.

The system also provides means for other members to access the deal. It also provides means for other individuals to promote the deal to a population of potential purchasers and means for the potential purchasers to purchase the deal.

The system also provides means for receiving deal payments from each of the purchasers for purchases of the deal. The system also provides for removing the deal from the platform when the deal is purchased by a pre-set number of the potential purchasers.

The system also provides for issuing a payment to the merchant from an amount collected from the deal payments.

In embodiments of the present invention, each of the members receives a primary-level payment when the member influences other individuals to become members and these other individuals purchase deals. Members also receive additional, lesser payments when these other individuals influence subsequent individuals to become members and these subsequent members make purchases.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a flow chart illustrating the overall operation of the invention;

FIG. 2 illustrates an example of a screen shot of a List a Deal phase of the invention;

FIG. 3 illustrates an example of a screen shot of an Influence a Deal phase of the invention; and

FIG. 4 illustrates an example of a screen shot of a Search for a Deal phase of the invention.

### DESCRIPTION OF THE PREFERRED EMBODIMENTS

The present invention is an Internet-based, self-service, social commerce platform that serves as a group deal exchange between consumers and merchants with a built-in revenue-sharing model. Members may earn commissions based upon their ability to successfully promote and influence group deals.

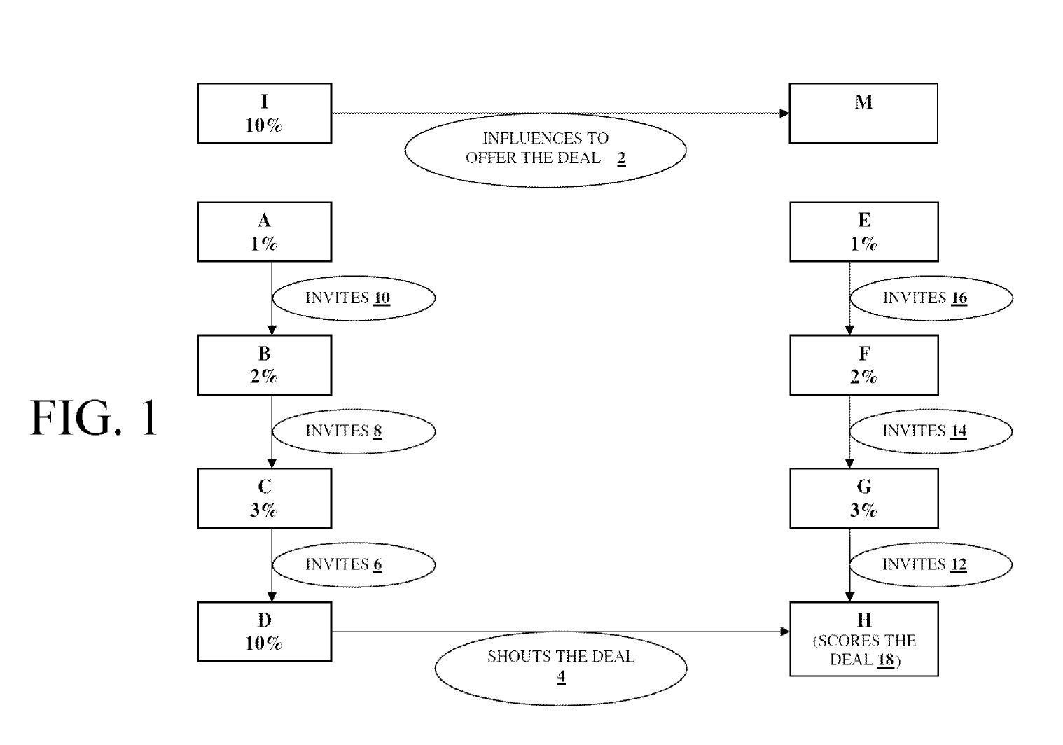

The various functions required for practicing the invention and referred to herein as a means for or means for achieving each specified function, can be programmed into website software that is well within the skill of the person of ordinary skill in the art of web design so that programming is not described here in detail, except as illustrated generally in the flow chart of FIG. 1.

The system works by providing an Internet-based platform that includes means for individuals to join. The individuals who join are designated as “members.” The system also provides means for members to invite merchants to offer group deals (“deals”) through the platform. The merchants who elect to participate and offer deals through the platform are also designated as members. Those members who successfully recruit merchants to join the platform and offer deals are designated as “influencers.” The system also includes a means for merchants to accept the invitations and offer a deal through the platform. Influencers are rewarded with commissions for having influenced a merchant to offer a deal but only if the deal is successful.

As noted, the means for allowing members to join the platform are well known attributes of many platforms such as facebook, myspace and others.

The system of the invention also provides a platform from which members may promote the deal. Such a platform may be operable through a social networking site such as, for example, facebook.com. Consumers initially join and set up their accounts through the social networking site.

The system also provides a means for others to become members, access these deals and purchase them. When a member purchases a deal, this is known as “scoring” the deal. When members influence other members to purchase a deal, they are paid commissions. When one member promotes a deal to other members, this is known as “shouting out a deal.”

In certain embodiments, deals may either close successfully or unsuccessfully. A “boom” is a deal which closes successfully. This is a deal which “scores” the requisite number of members within a pre-determined time period. Such a deal may also be referred to a “deal that booms.” In contrast, a deal that does not score the requisite number of members is referred to as a “bust.” It may also be referred to as a “deal that busts.”

In certain embodiments of the invention, a deal is removed from the system once it booms or busts.

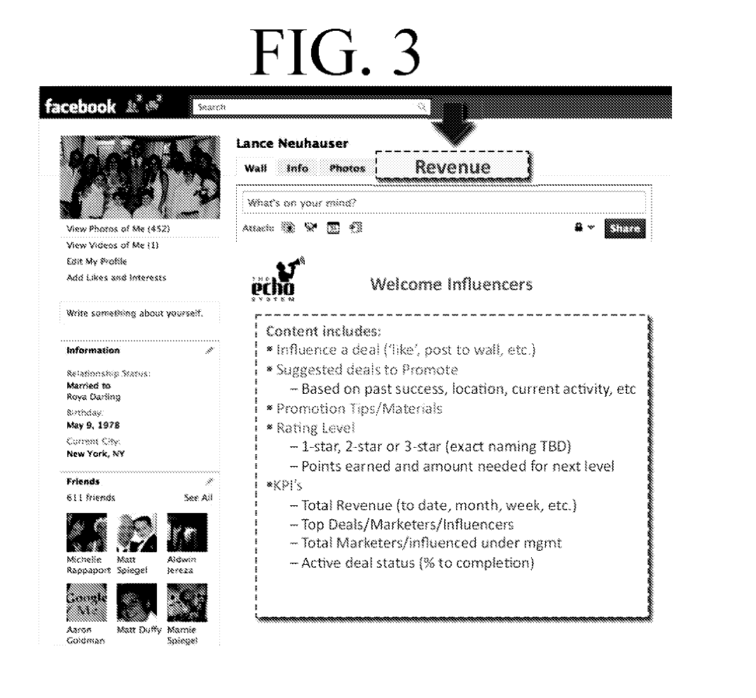

Members earn commissions for shouting a deal to another member who then scores the deal. Members also earn points for influencing merchants to offer a deal, if a deal is offered and if it is a “boom,” that is, it is successful. With reference to FIG. 3, a member's points earned may be viewed on the member's “Revenue” page. As an additional feature, members earn points based upon their degree of separation from the member who scored the deal as well as from the member who shouted the deal to the “scorer.” Thus, the present, novel system provides a motivation to invite those who are good promoters as well as those who are good candidates for making purchases.

Referring now to the drawings, FIG. 1 shows a flow diagram illustrating the present system for awarding members. In this example, Member I, influences merchant M to offer a deal, earning a 10% commission 2. When member D successfully shouts this deal to Member H, member H has “scored the deal” 18 and member D receives a 10% commission 4. The person who invited Member D 6, namely Member C, receives a 3% commission. Member B, who invited Member C 8, receives a 2% commission, and Member A, who invited Member B 10, receives a 1% commission. Simultaneously, the person who invited Member H 12, Member G, receives a 3% commission. Member F, who invited Member G 14, receives a 2% commission, and Member E, who invited Member F 16, receives a 1% commission.

The commissions paid are based on the value of the original deal. Additionally, the pay points earned are points per dollar. In the above example, because Member C invited Member D, Member D is a three-point “friend” to Member C. Likewise, because Member B invited Member C, Member D is a two-point “friend” to Member B. Likewise, because Member A invited Member B, Member D is a one-point “friend” to Member A. So, for example, if the deal that “boomed” was worth $30.00, Member C receives a 90-point commission (equivalent of 3%). Likewise, Member B receives a 60-point commission (equivalent of 2%). Finally, Member A receives a 30-point commission (equivalent of 1%).

The system also provides for receipt of payments for the deals from the purchasers as well as a means for issuing payments to a merchant from the total amount collected from a given deal. As noted in the example, commissions paid to members vary based on the degree of separation between the ultimate purchaser of the deal and the member receiving the commission.

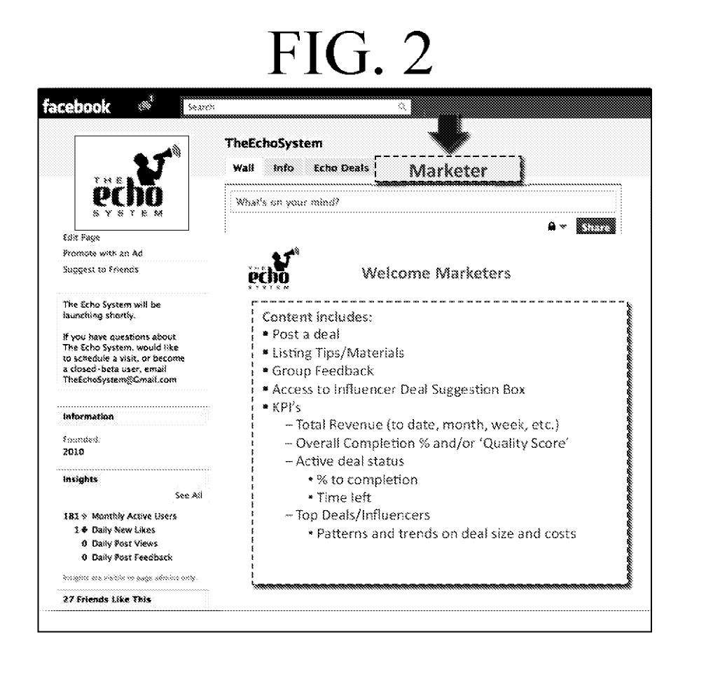

In some embodiments, members are eligible for two types of points, “access points” and “pay points.” Access points are non-monetary points which entitle members to access exclusive deal rooms and a deal suggestion box of top level merchants. With reference to FIG. 2, the member is provided access to this suggestion box via a “Marketer” page. These may be accumulated by, among other things, successfully inviting new members and new merchants to join, leaving feed back on deals, and creating a social-network event, such as, for example, on facebook.com, around a deal. Pay points are monetary points. In certain embodiments, one pay point is worth $0.01. Pay points are accumulated when a deal closes or “booms.”

In certain embodiments, member points are accumulated in an account from which members may withdraw once the balance has reached a minimum, such as, for example $50.00. Alternatively, members may choose to receive a bonus, such as, for example, 10% on their balance. This bonus may be earned in a variety of ways, including converting the balance to the propriety currency of the system, which may be used to purchase additional deals on the platform. A bonus may also be earned by converting the balance to propriety currency of the social network being employed. Additionally, a bonus may be earned by making a charitable donation of the balance through the system. These conversions are non-reversible. The conversion of the balance may be apportioned among the variety of options (e.g., part as proprietary currency, part as a charitable donation).

In certain embodiments, merchants are also assigned an account and can participate as members, thereby allowing them to accumulate member points, as well.

In some embodiments, transactional fees are subtracted from the merchant payment before the merchant payment is issued to the merchant. The proceeds from a given deal are split 50/50 between the system operator and the merchant. In these embodiments, commissions to members are paid out of system operators 50%.

In certain embodiments, the system also provides for a pre-set maximum total amount in commissions to be paid out to those associated with the “shout” and the “score.” As illustrated in the above example, this amount may be 22%.

Therefore, in certain exemplary embodiments, the breakdown of the payouts, is as follows: 50% is paid to the merchant. The maximum possible commission payments to be made to members associated with the “shout” and the “score” is 22%. The maximum potential payout to the member who influenced the merchant is 10%. The maximum bonus payments by the system's operator to all members in the aggregate, if they decide to convert their points from currency to system proprietary currency, social network proprietary currency, and/or charitable donations, would be 3.2% (10% of 22% plus 10%). Thus, the system operator's maximum payout to all parties associated with given deal would be 85.2%. This means that system operator's minimum gross margin for any given deal is 14.8%.

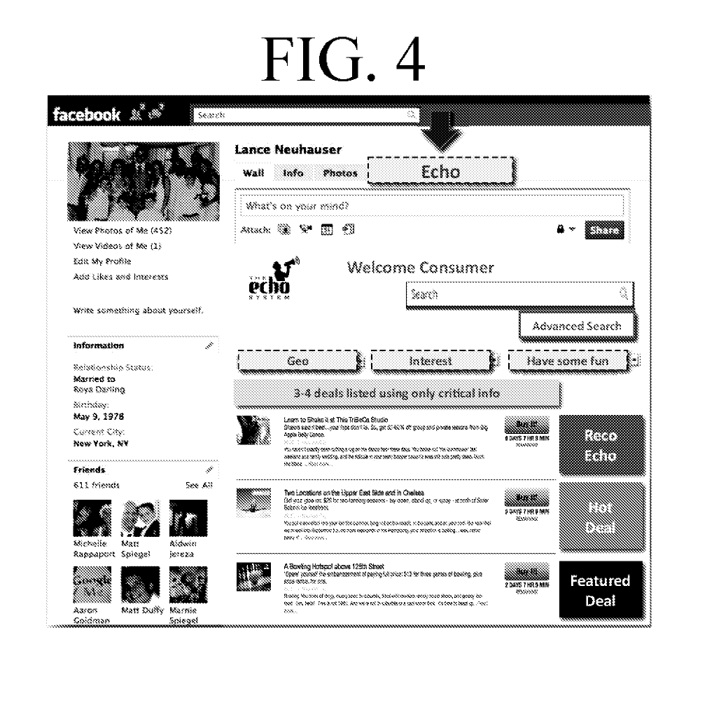

With reference to FIG. 4, embodiments of the present invention provide a search bar for locating deals listed on the platform. The search functionality provides the ability to find deals based on the searchers interests as well as his or her geographic location.

FIG. 2 is a screen shot of a List a Deal phase of the invention on a facebook platform. FIG. 3 is a screen shot of an Influence a Deal phase of the invention on facebook and FIG. 4 is a screen shot of a Search for a Deal phase of the invention.

While specific embodiments of the invention have been shown and described in detail to illustrate the application of the principles of the invention, it will be understood that the invention may be embodied otherwise without departing from such principles.

What is claimed is:

1. A method of promoting group deals on the Internet, comprising:
providing an Internet-based platform, said platform including means for individuals to join, wherein individuals who join are designated as members of said Internet-based platform;
providing means for a first member to provide an invitation to a merchant to offer a deal on said Internet-based platform;
providing means for said merchant to accept said invitation;
providing means for said merchant to offer said deal on said Internet-based platform;
providing an award to said first member when said merchant offers said deal;
providing means for at least a second member to access said deal;
providing means for said second individual to promote said deal to a population comprising potential purchasers;
providing means for said potential purchasers to purchase said deal;
receiving a deal payment from each of said purchasers for purchases of said deal by said purchasers; and
issuing a merchant payment to said merchant from an amount collected from said deal payments; and
wherein, each of said members receives a primary-level payment through said Internet-based platform when said members influence other individuals to become members and said other individuals purchase deals, each of said members receiving secondary-level payment when said other individuals influence subsequent individuals to become members and said subsequent individuals make purchases.

2. The method of claim 1, wherein said award comprises providing said first individual with access to exclusive deals.

3. The method of claim 1, wherein said award is a monetary award.

4. The method of claim 1, wherein a transactional fee is subtracted from said merchant payment before said merchant payment is issued to said merchant.

5. The method of claim 1, wherein said primary level payment and said secondary-level payments are accumulated in a member account associated with the member to whom said primary-level and said secondary-level payments were issued, said account having an account balance.

6. The method of claim 5, further comprising the step of enabling said member to make a withdrawal from said account when said account balance reaches a pre-set minimum.

7. The method of claim 5, wherein said member may cause said account balance to increase by converting said balance from government-sponsored currency to proprietary currency.

8. The method of claim 7, wherein said proprietary currency may be used by said member to purchase at least one of said deals.

9. The method of claim 5, wherein said member may cause said account balance to increase by making a charitable donations.

10. The method of claim 1, wherein said merchant payments are accumulated in a merchant account associated with the merchant to whom said merchant payments were issued, said account having an account balance.

11. The method of claim 1, further comprising the step of setting a limit to the total value of said primary-level payments.

12. The method of claim 1, further comprising the step of setting a limit to the total value of said secondary-level payments.

13. The method of claim 1, further comprising the step of setting a limit to the total value of the combination of said primary-level payments and said secondary-level payments.

14. The method claim 1, further comprising the step of removing said deal from said platform upon occurrence of a pre-set number of said purchases.

15. The method of claim 1, further comprising the step of removing said deal from said platform after the passage of a pre-determined period of time.

16. A program for promoting group deals on the Internet, comprising:
means for providing an Internet-based platform, said platform including means for individuals to join, wherein individuals who join are designated as members of said Internet-based platform;
means for providing a means for a first member to provide an invitation to a merchant to offer a deal on said Internet-based platform;
means for providing a means for said merchant to accept said invitation;
means for providing a means for said merchant to offer said deal on said Internet-based platform;
means for providing an award to said first member when said merchant offers said deal;
means for providing a means for at least a second member to access said deal;
means for providing a means for said second individual to promote said deal to a population comprising potential purchasers;
means for providing a means for said potential purchasers to purchase said deal;
means for receiving a deal payment from each of said purchasers for purchases of said deal by said purchasers; and
means for issuing a merchant payment to said merchant from an amount collected from said deal payments; and
wherein, each of said members receives a primary-level payment through said Internet-based platform when said members influence other individuals to become members and said other individuals purchase deals, each of said members receiving secondary-level payment when said other individuals influence subsequent individuals to become members and said subsequent individuals make purchases.

17. The program of claim 16, wherein said award comprises providing said first individual with access to exclusive deals.

18. The program of claim 16, further comprising a search functionality for locating said deals listed on said platform.

19. The program of claim 16, wherein said search functionality locates deals based an interest of a user.

20. The program of claim 16, wherein said search functionality locates deals based on a geographic location of a user.
